(19) United States
(12) Patent Application Publication
(10) Pub. No.: US 2025/0325942 A1
(43) Pub. Date: Oct. 23, 2025

(54) EXHAUST GAS TREATMENT METHOD AND EXHAUST GAS TREATMENT DEVICE

(71) Applicant: Resonac Corporation, Tokyo (JP)

(72) Inventors: Kunchan LEE, Tokyo (JP); Kazuki IWAGAKI, Tokyo (JP)

(73) Assignee: Resonac Corporation, Tokyo (JP)

(21) Appl. No.: 18/861,917

(22) PCT Filed: Dec. 12, 2023
(86) PCT No.: PCT/JP2023/044415

§ 371 Date: Oct. 31, 2024

(30) Foreign Application Priority Data
Dec. 19, 2022 (JP) 2022-202041

(51) Int. Cl. B01D 53/86; B01D 53/14; B01J 23/00; B01J 23/755; B01J 23/83

(52) U.S. Cl. CPC B01D 53/869; B01D 53/1456; B01D 53/1493; B01D 53/8662; B01J 23/002; B01J 23/755; B01J 23/83; B01D 2252/103; B01D 2255/2065; B01D 2255/20746; B01D 2255/20753; B01D 2255/20761; B01D 2255/2092; B01D 2255/40; B01D 2257/2025; B01D 2257/2045; B01D 2257/2066; B01D 2258/0216; B01J 2523/17; B01J 2523/31; B01J 2523/3712; B01J 2523/845

(57) ABSTRACT

Provided is an exhaust gas treatment method where chlorine gas and a perfluoro compound can be decomposed in exhaust gas containing the chlorine gas and the perfluoro compound to reduce both a concentration of the chlorine gas and a concentration of the perfluoro compound in the gas. The method of treating exhaust gas containing chlorine gas and a perfluoro compound includes: a chlorine gas decomposition step of causing the chlorine gas in the exhaust gas to react with water to be decomposed in the presence of a chlorine gas decomposition catalyst; a hydrogen chloride removal step of removing hydrogen chloride from the gas having passed through the chlorine gas decomposition step; and a perfluoro compound decomposition step of causing the perfluoro compound in the gas having passed through the hydrogen chloride removal step to react to be decomposed in the presence of a perfluoro compound decomposition catalyst.

### TECHNICAL FIELD

The present invention relates to an exhaust gas treatment method and an exhaust gas treatment device.

### BACKGROUND ART

When a semiconductor is manufactured, exhaust gas containing chlorine gas and a perfluoro compound (PFC) may be exhausted. Therefore, a treatment method of decomposing both of the chlorine gas and the perfluoro compound in the exhaust gas to reduce the concentrations is required. For example, PTL 1 discloses a treatment device that introduces exhaust gas into a reactor filled with both of a chlorine gas decomposition catalyst and a perfluoro compound decomposition catalyst to simultaneously decompose both of chlorine gas and a perfluoro compound.

### CITATION LIST

### Patent Literature

PTL 1: WO 2022/138850

### SUMMARY OF INVENTION

### Technical Problem

However, further improvement of a removal efficiency at which chlorine gas is decomposed and removed from exhaust gas is required.

An object of the present invention is to provide an exhaust gas treatment method and an exhaust gas treatment device where chlorine gas and a perfluoro compound can be decomposed in exhaust gas containing the chlorine gas and the perfluoro compound to reduce both of a concentration of the chlorine gas and a concentration of the perfluoro compound in the gas.

### Solution to Problem

To solve the above objects, one aspect of the present invention is as the following [1] to [10].

[1] An exhaust gas treatment method of treating exhaust gas containing chlorine gas and a perfluoro compound, the method including:
a chlorine gas decomposition step of causing the chlorine gas in the exhaust gas to react with water to be decomposed in a presence of a chlorine gas decomposition catalyst;
a hydrogen chloride removal step of removing hydrogen chloride from the gas having passed through the chlorine gas decomposition step; and
a perfluoro compound decomposition step of causing the perfluoro compound in the gas having passed through the hydrogen chloride removal step to react to be decomposed in a presence of a perfluoro compound decomposition catalyst.

[2] The exhaust gas treatment method according to [1],
in which the perfluoro compound decomposition step is a step of causing the perfluoro compound in the gas having passed through the hydrogen chloride removal step to react to be decomposed in the presence of the perfluoro compound decomposition catalyst and causing the chlorine gas in the gas having passed through the hydrogen chloride removal step to react to be decomposed in the presence of a chlorine gas decomposition catalyst.

[3] The exhaust gas treatment method according to [1] or [2],
in which the hydrogen chloride removal step is a step of removing the hydrogen chloride by bringing the gas having passed through the chlorine gas decomposition step into contact with water to dissolve the hydrogen chloride in the water.

[4] The exhaust gas treatment method according to any one of [1] to [3],
in which a decomposition reaction of the chlorine gas in the chlorine gas decomposition step is performed at a temperature of 500° C. or higher and 800° C. or lower.

[5] The exhaust gas treatment method according to any one of [1] to [4],
in which a decomposition reaction of the perfluoro compound in the perfluoro compound decomposition step is performed at a temperature of 500° C. or higher and 800° C. or lower.

[6] An exhaust gas treatment device for treating exhaust gas containing chlorine gas and a perfluoro compound, the device including:
a chlorine gas decomposition unit including a chlorine gas decomposition catalyst and configured to cause the chlorine gas in the exhaust gas to react with water to be decomposed in a presence of the chlorine gas decomposition catalyst;
a hydrogen chloride removal unit configured to remove hydrogen chloride from the gas from which the chlorine gas is decomposed by the chlorine gas decomposition unit; and
a perfluoro compound decomposition unit including a perfluoro compound decomposition catalyst and configured to cause the perfluoro compound in the gas from which the hydrogen chloride is removed by the hydrogen chloride removal unit to react to be decomposed in a presence of the perfluoro compound decomposition catalyst.

[7] The exhaust gas treatment device according to [6],
in which the perfluoro compound decomposition unit includes a chlorine gas decomposition catalyst in addition to the perfluoro compound decomposition catalyst, causes the perfluoro compound in the gas from which the hydrogen chloride is removed by the hydrogen chloride removal unit to react to be decomposed in the presence of the perfluoro compound decomposition catalyst, and causes the chlorine gas in the gas from which the hydrogen chloride is removed by the hydrogen chloride removal unit to react to be decomposed in the presence of the chlorine gas decomposition catalyst.

[8] The exhaust gas treatment device according to [6] or [7],
in which the hydrogen chloride removal unit removes the hydrogen chloride by bringing the gas from which the chlorine gas is decomposed by the chlorine gas decomposition unit into contact with water to dissolve the hydrogen chloride in the water.

[9] The exhaust gas treatment device according to any one of [6] to [8],
in which the chlorine gas decomposition unit performs a decomposition reaction of the chlorine gas at a temperature of 500° C. or higher and 800° C. or lower.

[10] The exhaust gas treatment device according to any one of [6] to [9],
in which the perfluoro compound decomposition unit performs a decomposition reaction of the perfluoro compound at a temperature of 500° C. or higher and 800° C. or lower.

### Advantageous Effects of Invention

According to the present invention, chlorine gas and a perfluoro compound can be decomposed in exhaust gas containing the chlorine gas and the perfluoro compound to reduce both of a concentration of the chlorine gas and a concentration of the perfluoro compound in the gas.

### BRIEF DESCRIPTION OF DRAWINGS

FIG. 1 is a schematic conceptual view illustrating an example of an exhaust gas treatment device that performs an exhaust gas treatment method according to the present invention.

### DESCRIPTION OF EMBODIMENTS

Embodiments of the present invention will now be described. The embodiments are merely examples of the present invention, and the present invention is not limited to the embodiments. Various modifications or improvements can be made in the embodiments, and such modifications and improvements can be encompassed by the present invention.

An exhaust gas treatment method according to the present embodiment is a method of treating exhaust gas containing chlorine gas and a perfluoro compound, the method including: a chlorine gas decomposition step of causing the chlorine gas in the exhaust gas to react with water to be decomposed in the presence of a chlorine gas decomposition catalyst; a hydrogen chloride removal step of removing hydrogen chloride from the gas having passed through the chlorine gas decomposition step; and a perfluoro compound decomposition step of causing the perfluoro compound in the gas having passed through the hydrogen chloride removal step to react to be decomposed in the presence of a perfluoro compound decomposition catalyst.

An exhaust gas treatment device according to the present embodiment is a device that treats exhaust gas containing chlorine gas and a perfluoro compound, the device including: a chlorine gas decomposition unit including a chlorine gas decomposition catalyst and configured to cause the chlorine gas in the exhaust gas to react with water to be decomposed in the presence of the chlorine gas decomposition catalyst; a hydrogen chloride removal unit configured to remove hydrogen chloride from the gas from which the chlorine gas is decomposed by the chlorine gas decomposition unit; and a perfluoro compound decomposition unit including a perfluoro compound decomposition catalyst and configured to cause the perfluoro compound in the gas from which the hydrogen chloride is removed by the hydrogen chloride removal unit to react to be decomposed in the presence of the perfluoro compound decomposition catalyst.

When chlorine gas (Cl₂) is caused to react with water (H₂O) and hydrolyzed, hydrogen chloride (HCL) and oxygen gas (O₂) are produced as shown in the following reaction formula.

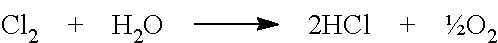

This reaction is an equilibrium reaction. Therefore, when the concentration of hydrogen chloride increases, a reverse reaction of the hydrolysis reaction occurs, and chlorine gas is reproduced by oxidation of the hydrogen chloride. Accordingly, to suppress the reproduction of chlorine gas to reduce the concentration of chlorine gas in the gas, the hydrogen chloride produced by the hydrolysis of the chlorine gas needs to be removed.

In the exhaust gas treatment method according to the present embodiment, the hydrogen chloride removal step is performed after the chlorine gas decomposition step. Therefore, the reproduction of chlorine gas is not likely to occur after the hydrogen chloride removal step. By the perfluoro compound decomposition step after the hydrogen chloride removal step, the perfluoro compound is removed from the gas from which the hydrogen chloride is removed. Therefore, both of the concentration of the chlorine gas and the concentration of the perfluoro compound in the gas can be reduced.

In addition, the exhaust gas treatment device according to the present embodiment includes the hydrogen chloride removal unit configured to remove hydrogen chloride from the gas from which the chlorine gas is decomposed by the chlorine gas decomposition unit. Therefore, in the gas from which the hydrogen chloride is removed by the hydrogen chloride removal unit, the reproduction of chlorine gas is not likely to occur. The exhaust gas treatment device according to the present embodiment includes the perfluoro compound decomposition unit. Therefore, both of the concentration of the chlorine gas and the concentration of the perfluoro compound in the gas can be reduced.

For example, the concentration of the chlorine gas in the gas after the end of the decomposition of the perfluoro compound can be reduced to be 0.5 ppm by volume or less with respect to 100 to 10000 ppm by volume of the chlorine gas in the exhaust gas, and the concentration of the perfluoro compound in the gas after the end of the decomposition of the perfluoro compound can be reduced to be 100 ppm by volume or less with respect to 1000 to 10000 ppm by volume of the perfluoro compound in the exhaust gas.

Hereinafter, the exhaust gas treatment method and the exhaust gas treatment device according to the present embodiment will be described in more detail.

### [Exhaust Gas]

The kind of the exhaust gas that can be treated by the exhaust gas treatment method and the exhaust gas treatment device according to the present embodiment is not particularly limited, and can be treated as long as it is gas containing chlorine gas and a perfluoro compound. The exhaust gas may contain other components in addition to chlorine gas and a perfluoro compound, and may contain, for example, at least one among argon (Ar), nitrogen gas (N₂), oxygen gas, and water.

Both of the concentration of the chlorine gas and the concentration of the perfluoro compound in the pre-treated exhaust gas are not particularly limited, and are preferably 0.01% by volume or more and 10% by volume or less and more preferably 0.1% by volume or more and 1% by volume or less. In addition, the total concentration of the chlorine gas and the perfluoro compound is preferably 1% by volume or less.

Examples of the exhaust gas include gas that is exhausted in the process of manufacturing a compound and gas that is exhausted in various industrial processes. More specific examples of the exhaust gas include etching gas that is used in a manufacturing step of a semiconductor or a manufacturing step of a liquid crystal display element and cleaning gas that is used by a chemical vapor deposition device (CVD device). These exhaust gases may contain chlorine gas and a perfluoro compound.

### [Perfluoro Compound]

The perfluoro compound is a compound not containing a chlorine atom and is a collective term for a compound consisting of a carbon atom and a fluorine atom, a compound consisting of a carbon atom, a hydrogen atom, and a fluorine atom, a compound consisting of a sulfur atom and a fluorine atom, and a compound consisting of a nitrogen atom and a fluorine atom.

Specific examples of the perfluoro compound include carbon tetrafluoride (CF₄), trifluoromethane (CHF₃), hexafluoroethane (C₂F₆), 1,1-difluoroethylene (CH₂F₂), cis-1,2-difluoroethylene (CH₂F₂), trans-1,2-difluoroethylene (CH₂F₂), octafluoropropane (C₃F₈), octafluorocyclobutane (C₄F₈), octafluorocyclopentene (C₅F₈), sulfur hexafluoride (SF₆), and nitrogen trifluoride (NF₃).

### [Chlorine Gas Decomposition Catalyst]

The chlorine gas decomposition catalyst is not particularly limited as long as it is a catalyst that promotes the hydrolysis reaction of chlorine gas, and preferably contains at least one of cerium oxide (CeO₂) and cobalt oxide (CoO, Co₂O₃).

The chlorine gas decomposition catalyst may contain other metal oxides in addition to at least one of cerium oxide and cobalt oxide. Examples of the other metal oxides include at least one among aluminum oxide (Al₂O₃), magnesium oxide (MgO), chromium oxide (Cro, Cr₂O₃, CrO₂, CrO₃), manganese oxide (MnO, Mn₂O₃, MnO₂, MnO₃, Mn₂O₇), iron oxide (FeO, Fe₂O₃), nickel oxide (NiO), copper oxide (Cu₂O, CuO), and zirconium oxide (ZrO₂). The mass ratio between the component elements of the chlorine gas decomposition catalyst is preferably (cerium):(cobalt):(copper):(aluminum):(oxygen)=(5 to 15):(5 to 15):(0.1 to 0.5):(25 to 45):(40 to 50).

Further, the chlorine gas decomposition catalyst may contain other complex oxides of cerium (Ce) and other metals in addition to at least one of cerium oxide and cobalt oxide. Examples of the other metals forming the complex oxides include at least one among magnesium (Mg), chromium (Cr), manganese (Mn), iron (Fe), cobalt (Co), nickel (Ni), copper (Cu), and zirconium (Zr).

Further, the chlorine gas decomposition catalyst may contain at least one of cerium oxide and cobalt oxide, at least one of the above-described other metal oxides, and at least one of the above-described complex oxides.

The chlorine gas decomposition catalyst may be used for decomposing chlorine gas in a state where the catalyst is supported on a carrier, or may be used as it is for decomposing chlorine gas in a state where the catalyst is not supported on the carrier.

The shape or size of the carrier is not particularly limited. For example, a structure such as a bead shape, a pellet shape, a powder shape, a granular shape, or a monolithic shape is preferable, and a pellet shape is particularly preferable.

In addition, the carrier is preferably formed of a porous material, and a specific surface area measured using a BET method may be 100 cm²/g or more and 500 cm²/g or less, or may be 100 cm²/g or more and 300 cm²/g or less.

The material of the carrier is preferably inactive or less reactive with chlorine gas or hydrogen chloride. Examples of the material include alumina (Al₂O₃), silica (SiO₂), cordierite, and zeolite, and alumina is preferable.

The average particle diameter (diameter) of the carrier may be 1 mm or more and 10 mm or less or may be 2 mm or more and 5 mm or less.

### [Chlorine Gas Decomposition Step, Chlorine Gas Decomposition Unit]

Examples of the chlorine gas decomposition unit where the decomposition reaction of the chlorine gas is performed include a reactor. When the exhaust gas is introduced into the reactor including the chlorine gas decomposition catalyst therein, the chlorine gas decomposition step can be performed.

The material of the reactor is preferably inactive or less reactive with chlorine gas or hydrogen chloride. For example, a nickel alloy can be used, and specific examples of the nickel alloy include INCONEL (registered trademark) 600, INCONEL (registered trademark) 601, and INCONEL (registered trademark) 625.

The decomposition reaction of the chlorine gas is a reaction of causing the chlorine gas in the exhaust gas to react with water in the presence of the chlorine gas decomposition catalyst for hydrolysis. Therefore, the decomposition reaction of the chlorine gas needs to be performed in the presence of water. As long as water can come into contact with the chlorine gas in the exhaust gas, the water may be liquid water or gaseous water (water vapor) and is typically water vapor.

When the exhaust gas sufficiently contains water, the chlorine gas decomposition step may be performed on the exhaust gas as it is. When the exhaust gas does not contain water at all, the chlorine gas decomposition step needs to be performed after adding water to the exhaust gas or while adding water to the exhaust gas. Accordingly, in this case, the exhaust gas treatment device according to the present embodiment needs to include a water supply unit configured to add water to the exhaust gas.

In addition, when the exhaust gas sufficiently does not contain water and the concentration of water in the exhaust gas is low, it is preferable that the chlorine gas decomposition step is performed after adding water to the exhaust gas to increase the concentration of water or while adding water to the exhaust gas. Accordingly, in this case, it is preferable that the exhaust gas treatment device according to the present embodiment includes the water supply unit configured to add water to the exhaust gas.

The concentration of water in the exhaust gas is preferably 1% by volume or more and 40% by volume or less and more preferably 10% by volume or more and 25% by volume or less. In a case where the concentration of water in the exhaust gas is lower than the lower limit value of the above-described numerical range, when the chlorine gas decomposition step is performed, it is preferable that water is added to the exhaust gas such that the concentration of water in the exhaust gas is higher than the lower limit value of the above-described numerical range.

A temperature condition and a pressure condition of the chlorine gas decomposition step are not particularly limited as long as the decomposition of the chlorine gas progresses. The temperature condition is preferably 300° C. or higher and 1000° C. or lower, more preferably 400° C. or higher and 800° C. or lower, and still more preferably 500° C. or higher and 800° C. or lower.

The pressure condition is preferably a normal pressure or pressurized state and more preferably a normal pressure.

By performing the chlorine gas decomposition step on the exhaust gas, the chlorine gas is decomposed. Therefore, the concentration of the chlorine gas in the gas having passed through the chlorine gas decomposition step can be reduced to be 300 ppm by volume or less.

Before performing the chlorine gas decomposition step, a treatment bringing the exhaust gas into contact with water may be performed. For example, a gas-liquid contact treatment of bringing the exhaust gas into contact with water using a wet-type gas cleaning device (water scrubber) may be performed. As a result, water-soluble gas can be removed from the exhaust gas.

### [Hydrogen Chloride Removal Step, Hydrogen Chloride Removal Unit]

The gas from which the chlorine gas is decomposed through the chlorine gas decomposition step contains hydrogen chloride. As described above, there is a concern that chlorine gas may be reproduced by oxidation of hydrogen chloride. Hydrogen chloride needs to be removed from the gas having passed through the chlorine gas decomposition step by the hydrogen chloride removal step.

A method of removing hydrogen chloride is not particularly limited. It is preferable that the hydrogen chloride removal step is a step of removing the hydrogen chloride by bringing the gas having passed through the chlorine gas decomposition step into contact with water to dissolve the hydrogen chloride in water. For example, by performing a gas-liquid contact treatment of bringing the gas having passed through the chlorine gas decomposition step into contact with water using a wet-type gas cleaning device (water scrubber) as the hydrogen chloride removal unit, the hydrogen chloride is dissolved in water. Therefore, the hydrogen chloride can be removed from the gas having passed through the chlorine gas decomposition step.

In addition, the hydrogen chloride may be removed from the gas having passed through the chlorine gas decomposition step using a method of adsorbing the hydrogen chloride on an adsorbent such as activated carbon. For example, by using an adsorption tower filled with an adsorbent as the hydrogen chloride removal unit to introduce the gas having passed through the chlorine gas decomposition step into the adsorption tower, the hydrogen chloride can be removed from the gas having passed through the chlorine gas decomposition step.

Conditions when the hydrogen chloride is removed from the exhaust gas using the water scrubber will be described. In order to increase the contact frequency between the exhaust gas and water, the supply amount of water to the water scrubber is preferably large, and the supply amount of water to the water scrubber is preferably 2.5% or more with respect to the flow rate of the exhaust gas. For example, when the flow rate of the exhaust gas is 400 L/min, the supply rate of water is preferably 10 L/min or more.

In order to increase the solubility of hydrogen chloride in water, the temperature of water supplied to the water scrubber is preferably low and is preferably 25° C. or lower.

In order to suppress the occurrence of clogging in a pipe through which water is exhausted from the water scrubber, water having a low concentration of metal ions is preferably used as the water supplied to the water scrubber. When water contains metal ions such as magnesium ions or calcium ions, there is a concern that the metal ions and hydrogen chloride may react with each other to produce a metal salt which causes clogging of the pipe.

### [Perfluoro Compound Decomposition Catalyst]

The perfluoro compound decomposition catalyst is not particularly limited as long as it is a catalyst that promotes the decomposition reaction of the perfluoro compound. For example, it is preferable that the perfluoro compound decomposition catalyst contains nickel oxide (NIO), aluminum oxide (Al₂O₃), or a mixture thereof. Further, it is preferable that the perfluoro compound decomposition catalyst contains a complex oxide containing nickel and at least one element among aluminum (Al), tungsten (W), titanium (Ti) and zirconium.

The mass ratio of the component elements of the perfluoro compound decomposition catalyst is preferably (nickel):(aluminum):(oxygen)=(20 to 30):(30 to 40):(30 to 50).

When the perfluoro compound decomposition catalyst is a metal oxide, the perfluoro compound decomposition catalyst also functions as the chlorine gas decomposition catalyst. Therefore, the chlorine gas remaining in the gas having passed through the chlorine gas decomposition step can be decomposed in the perfluoro compound decomposition step.

The perfluoro compound decomposition catalyst may be used for decomposing the perfluoro compound in a state where the catalyst is supported on a carrier, and may be used as it is for decomposing the perfluoro compound in a state where the catalyst is not supported on the carrier. Since the carrier is the same as that of the chlorine gas decomposition catalyst, the detailed description will not be repeated.

### [Perfluoro Compound Decomposition Step, Perfluoro Compound Decomposition Unit]

Examples of the perfluoro compound decomposition unit where the decomposition reaction of the perfluoro compound is performed include a reactor. By introducing the gas having passed through the hydrogen chloride removal step into the reactor including the perfluoro compound decomposition catalyst therein, the perfluoro compound decomposition step can be performed.

The material of the reactor is preferably inactive or less reactive with chlorine gas or hydrogen chloride. For example, a nickel alloy can be used, and specific examples of the nickel alloy include INCONEL (registered trademark) 600, INCONEL (registered trademark) 601, and INCONEL (registered trademark) 625.

The kind of the decomposition reaction of the perfluoro compound is not particularly limited as long as the perfluoro compound is decomposed in the gas having passed through the hydrogen chloride removal step. For example, the decomposition reaction may be a thermal decomposition reaction or may be a reaction of causing the perfluoro compound to react with water for hydrolysis. An example of the hydrolysis reaction of the perfluoro compound is as follows.

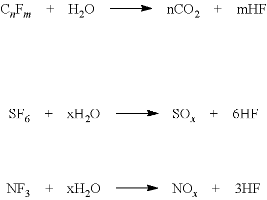

When the decomposition reaction of the perfluoro compound is the hydrolysis reaction, the decomposition reaction of the perfluoro compound needs to be performed in the presence of water. As long as water can come into contact with the perfluoro compound in the gas having passed through the hydrogen chloride removal step, the water may be liquid water or gaseous water (water vapor) and is typically water vapor.

When the gas having passed through the hydrogen chloride removal step sufficiently contains water, the perfluoro compound decomposition step may be performed as it is on the gas having passed through the hydrogen chloride removal step. When the gas having passed through the hydrogen chloride removal step does not contain water at all, the perfluoro compound decomposition step needs to be performed after adding water to the gas having passed through the hydrogen chloride removal step or while adding water to the gas having passed through the hydrogen chloride removal step. Accordingly, in this case, the exhaust gas treatment device according to the present embodiment needs to include a water supply unit configured to add water to the gas having passed through the hydrogen chloride removal step.

In addition, when the gas having passed through the hydrogen chloride removal step does not sufficient contain water and the concentration of water in the gas having passed through the hydrogen chloride removal step is low, it is preferable that the perfluoro compound decomposition step is performed after adding water to the gas having passed through the hydrogen chloride removal step to increase the concentration of water or while adding water to the gas having passed through the hydrogen chloride removal step. Accordingly, in this case, it is preferable that the exhaust gas treatment device according to the present embodiment includes the water supply unit configured to add water to the gas having passed through the hydrogen chloride removal step.

The concentration of water in the gas having passed through the hydrogen chloride removal step is preferably 1% by volume or more and 40% by volume or less and more preferably 10% by volume or more and 25% by volume or less. In a case where the concentration of water in the gas having passed through the hydrogen chloride removal step is lower than the lower limit value of the above-described numerical range, when the perfluoro compound decomposition step is performed, it is preferable that water is added to the gas having passed through the hydrogen chloride removal step such that the concentration of water in the gas having passed through the hydrogen chloride removal step is higher than the lower limit value of the above-described numerical range.

A temperature condition and a pressure condition of the perfluoro compound decomposition step are not particularly limited as long as the decomposition of the perfluoro compound progresses. Irrespective of whether the decomposition reaction of the perfluoro compound is the thermal decomposition reaction or the hydrolysis reaction, the temperature condition is preferably 300° C. or higher and 1000° C. or lower, more preferably 400° C. or higher and 800° C. or lower, and still more preferably 500° C. or higher and 800° C. or lower.

Irrespective of whether the decomposition reaction of the perfluoro compound is the thermal decomposition reaction or the hydrolysis reaction, the pressure condition is preferably a normal pressure or pressurized state and more preferably a normal pressure.

By performing the perfluoro compound decomposition step on the gas having passed through the hydrogen chloride removal step, the perfluoro compound is decomposed at a high decomposition rate of 99% or more. Therefore, the concentration of the perfluoro compound in the gas having passed through the perfluoro compound decomposition step can be reduced to be 100 ppm by volume or less with respect to 1000 to 10000 ppm by volume of the perfluoro compound in the gas after the hydrogen chloride removal step.

When the gas having passed through the hydrogen chloride removal step contains chlorine gas that is not decomposed in the chlorine gas decomposition step, there is a case where the chlorine gas that is not decomposed in the perfluoro compound decomposition step can be decomposed depending on the kind of the perfluoro compound decomposition catalyst. For example, the metal oxide such as nickel oxide also functions as the chlorine gas decomposition catalyst. Therefore, when the metal oxide such as nickel oxide is used as the perfluoro compound decomposition catalyst, the perfluoro compound and the chlorine gas are decomposed in the perfluoro compound decomposition step. When the chlorine gas is decomposed in the perfluoro compound decomposition step, Therefore, the concentration of the chlorine gas in the gas having passed through the perfluoro compound decomposition step can be reduced to be 0.5 ppm by volume or less with respect to 10 to 100 ppm by volume of the chlorine gas in the gas after the hydrogen chloride removal step.

As described above, the gas having passed through the hydrogen chloride removal step may contain chlorine gas that is not decomposed in the chlorine gas decomposition step. Therefore, irrespective of whether the perfluoro compound decomposition catalyst is a catalyst that is effective for decomposing the chlorine gas, not only the perfluoro compound decomposition catalyst but also the chlorine gas decomposition catalyst may be used in the perfluoro compound decomposition step. That is, the perfluoro compound decomposition unit may include the perfluoro compound decomposition catalyst and the chlorine gas decomposition catalyst.

When not only the perfluoro compound decomposition catalyst but also the chlorine gas decomposition catalyst are used in the perfluoro compound decomposition step, the perfluoro compound decomposition step is a step of causing the perfluoro compound in the gas having passed through the hydrogen chloride removal step to react to be decomposed in the presence of the perfluoro compound decomposition catalyst and causing the chlorine gas in the gas having passed through the hydrogen chloride removal step to react to be decomposed in the presence of the chlorine gas decomposition catalyst.

In addition, when the perfluoro compound decomposition unit includes not only the perfluoro compound decomposition catalyst and but also the chlorine gas decomposition catalyst, the perfluoro compound decomposition unit causes the perfluoro compound in the gas from which the hydrogen chloride is removed by the hydrogen chloride removal unit to react to be decomposed in the presence of the perfluoro compound decomposition catalyst, and causes the chlorine gas in the gas from which the hydrogen chloride is removed by the hydrogen chloride removal unit to react to be decomposed in the presence of the chlorine gas decomposition catalyst.

By using the perfluoro compound decomposition catalyst and the chlorine gas decomposition catalyst in the perfluoro compound decomposition step, the chlorine gas that is not decomposed in the chlorine gas decomposition step can be decomposed in the perfluoro compound decomposition step. Accordingly, the concentration of the chlorine gas in the gas can be further reduced.

In addition, after performing the perfluoro compound decomposition step, a treatment of bringing the gas having passed through the perfluoro compound decomposition step into contact with water may be performed. For example, by performing a gas-liquid contact treatment of bringing the gas having passed through the perfluoro compound decomposition step into contact with water using a wet-type gas cleaning device (water scrubber), hydrogen chloride or hydrogen fluoride can be removed from the gas having passed through the perfluoro compound decomposition step. This hydrogen fluoride is produced by decomposition of the perfluoro compound. When hydrogen chloride or hydrogen fluoride is removed from the gas having passed through the perfluoro compound decomposition step, the main component of abatement gas exhausted from the gas cleaning device through the perfluoro compound decomposition step is carbon dioxide (CO₂).

### EXAMPLES

Hereinafter, the present invention will be described in more detail with reference to Examples and Comparative Examples.

### Example 1

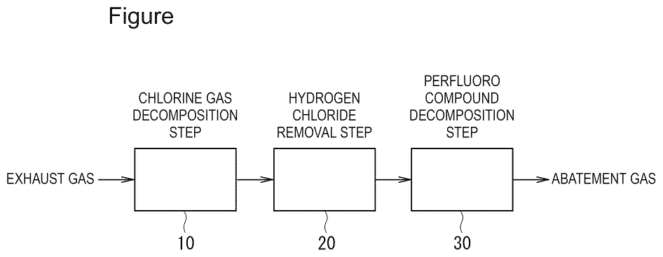

Using an exhaust gas treatment device exhaust gas containing chlorine gas and a perfluoro compound was treated to perform abatement of the exhaust gas. The configuration of the exhaust gas treatment device used in Example 1 will be described with reference to a schematic conceptual view of FIG. 1.

The exhaust gas treatment device of FIG. 1 includes: a chlorine gas decomposition unit 10 that performs the chlorine gas decomposition step of causing the chlorine gas in the exhaust gas to react with water to be decomposed in the presence of a chlorine gas decomposition catalyst; a hydrogen chloride removal unit 20 that performs the hydrogen chloride removal step of removing hydrogen chloride from the gas having passed through the chlorine gas decomposition step; and a perfluoro compound decomposition unit 30 that performs the perfluoro compound decomposition step of causing the perfluoro compound in the gas having passed through the hydrogen chloride removal step to react to be decomposed in the presence of a perfluoro compound decomposition catalyst.

The chlorine gas decomposition unit 10 is a reactor (volume: 70 mL) formed of Inconel (registered trademark), and the inside thereof is filled with 65 g (volume: 70 mL) of a chlorine gas decomposition catalyst having a pellet shape with a diameter of 3.2 mm and a length of 10 mm. The chlorine gas decomposition catalyst is obtained by kneading cerium nitrate, cobalt nitrate, copper nitrate, and boehmite and extruding and sintering the kneaded product. The chlorine gas decomposition catalyst is a mixture of cerium oxide (CeO₂), cobalt oxide (CoO), copper oxide (CuO), and aluminum oxide (Al₂O₃), and the mass ratio of the component elements is cerium:cobalt:copper:aluminum:oxygen=11.8:7.5:0.2:36.0:44.5.

The hydrogen chloride removal unit 20 is a water scrubber. The perfluoro compound decomposition unit 30 is a reactor (volume: 70 mL) formed of Inconel (registered trademark), and the inside thereof is filled with 60 g (volume: 70 mL) of a perfluoro compound decomposition catalyst having a pellet shape with a diameter of 3 mm and a length of 10 mm. The perfluoro compound decomposition catalyst is obtained by kneading nickel nitrate and boehmite and extruding and sintering the kneaded product. The perfluoro compound decomposition catalyst is a mixture of nickel oxide (NiO) and aluminum oxide (Al₂O₃), and the mass ratio of the component elements is nickel:aluminum:oxygen=23:37:40.

In the exhaust gas treatment device of FIG. 1, the exhaust gas is introduced into the chlorine gas decomposition unit 10, and the chlorine gas decomposition step is performed to hydrolyze chlorine gas in the exhaust gas. The gas having passed through the chlorine gas decomposition step is exhausted from the chlorine gas decomposition unit 10 and is introduced into the hydrogen chloride removal unit 20.

In the hydrogen chloride removal unit 20, the hydrogen chloride removal step is performed to remove hydrogen chloride in the gas having passed through the chlorine gas decomposition step.

The gas having passed through the hydrogen chloride removal step is exhausted from the hydrogen chloride removal unit 20 and is introduced into the perfluoro compound decomposition unit 30. In the perfluoro compound decomposition unit 30, the perfluoro compound decomposition step is performed to hydrolyze the perfluoro compound and the chlorine gas in the gas having passed through the hydrogen chloride removal step. The gas from which the chlorine gas and the perfluoro compound are removed is exhausted from the perfluoro compound decomposition unit 30 as the abatement gas.

The composition of the exhaust gas that is treated by the exhaust gas treatment device illustrated in FIG. 1 is as follows. That is, this exhaust gas is mixed gas of chlorine gas, octafluorocyclobutane, nitrogen gas, water vapor, and oxygen gas, and the volume ratio is chlorine gas:octafluorocyclobutane:nitrogen gas:water vapor:oxygen gas=0.5:0.5:82:15:2.

Specifically, the chlorine gas, the octafluorocyclobutane, the nitrogen gas, and air are mixed at the above-described volume ratio while adjusting the volumes with a mass flow controller, and the mixture is introduced into the chlorine gas decomposition unit 10 at a normal pressure. On the other hand, pure water at a normal temperature is introduced into a preheating unit (not illustrated) and vaporized at 400° C., and the obtained water vapor is introduced into the chlorine gas decomposition unit 10 such that the composition of the mixed gas of the chlorine gas, the octafluorocyclobutane, the nitrogen gas, the water vapor, and the oxygen gas is the above-described volume ratio. The supply rate of the mixed gas of the chlorine gas, the octafluorocyclobutane, the nitrogen gas, the water vapor, and the oxygen gas to the chlorine gas decomposition unit 10 is 5 L/min in terms of a standard state (0° C., 1.01×10⁵ Pa).

While supplying the mixed gas (exhaust gas) to the chlorine gas decomposition unit 10 as described above, the decomposition reaction of the chlorine gas was performed at 525° C. in the chlorine gas decomposition unit 10. After performing the decomposition reaction of the chlorine gas for 1 hour, the mixed gas (exhaust gas) supplied to the chlorine gas decomposition unit 10 and the gas exhausted from the chlorine gas decomposition unit 10 were collected, respectively, to measure the concentrations of the chlorine gas, the octafluorocyclobutane, and the hydrogen chloride in each of the gases. Table 1 shows the results. In Table 1, the octafluorocyclobutane is shown as “PFC”.

TABLE 1

| | | | | Gas Exhausted from Chlorine | | | Gas Exhausted from Hydrogen | | | | | | |
|---|---|---|---|---|---|---|---|---|---|---|---|---|---|
| | Exhaust Gas | | | Gas Decomposition Unit | | | Chloride Removal Unit | | | Abatement Gas | | | |
| | Cl₂ | HCl | PFC | Cl₂ | HCl | PFC | Cl₂ | HCl | PFC | Cl₂ | Cl₂ | PFC | PFC |
| | Concen- | Concen- | Concen- | Concen- | Concen- | Concen- | Concen- | Concen- | Concen- | Concen- | Abatement | Concen- | Abatement |
| | tration | tration | tration | tration | tration | tration | tration | tration | tration | tration | Ratio | tration | Ratio |
| Ex. 1 | 5000 | 0 | 5000 | 59 | 9880 | 5000 | 59 | 0 | 5000 | 0 | 100 | 27.0 | 99.46 |
| Ex. 2 | 5000 | 0 | 5000 | 26 | 9948 | 5000 | 26 | 0 | 5000 | 0 | 100 | 24.0 | 99.52 |
| Comp. Ex. 1 | 5000 | 0 | 5000 | 59 | 9880 | 5000 | — | — | — | 41 | 99.18 | 29.5 | 99.41 |
| Comp. Ex. 2 | 5000 | 0 | 5000 | — | — | — | — | — | — | 31 | 99.31 | 8.5 | 99.83 |

*) Regarding the units of numerical values, the unit of the concentration is ppm by volume, and the unit of the abatement ratio is %.

A method of measuring the concentration of the chlorine gas in the gas is as follows. The gas (the exhaust gas supplied to the chlorine gas decomposition unit 10 or the gas exhausted from the chlorine gas decomposition unit 10) was caused to flow through 100 g of a potassium iodide aqueous solution having a concentration of 1.0% by mass for 15 minutes. By titration of the potassium iodide aqueous solution after the gas flow based on an iodine titration method, the amount of the chlorine gas in the gas was calculated.

A method of measuring the concentration of the octafluorocyclobutane in the gas is as follows. That is, analysis target gas of 1 cm³ was sampled using a syringe, was injected into a gas chromatography (GC-14B, manufactured by Shimadzu Corporation detector: TCD) to which various factors were input such that the concentration of the analysis target gas was able to be quantitatively analyzed, and the concentration was measured.

As a method of measuring the concentration of the hydrogen chloride in the gas, the following two methods were used for the gas after the chlorine gas decomposition step and the gas after the hydrogen chloride decomposition step described below.

First, when the analysis target gas did not contain chlorine gas, the concentration of the hydrogen chloride in the gas was measured using a detector tube gas measuring device including a hydrogen chloride detector tube (hydrogen chloride 14L, manufactured by Gastec Corporation) and a gas collector (GV-100, manufactured by Gastec Corporation). That is, a constant volume (500 mL) of the gas was aspirated by the detector tube gas measuring device, and the concentration of the hydrogen chloride was measured based on the length of the colored portion of the detector tube through which the gas flowed (hereinafter, referred to as “A method”).

On the other hand, when the analysis target gas contains chlorine gas, the chlorine gas interferes with detection of hydrogen chloride, and thus the A method cannot be adopted. Accordingly, the concentration of the chlorine gas was measured using the iodine titration method, and a difference between the concentration of the chlorine gas before the step and the concentration of the chlorine gas after the step was considered to be converted into the concentration of hydrogen chloride. As a result, the concentration of the hydrogen chloride was calculated (hereinafter, referred to as “B method”).

The concentration of the hydrogen chloride in the gas after the chlorine gas decomposition step was measured using the B method because the analysis target gas contained chlorine gas.

The concentration of the hydrogen chloride in the gas after the hydrogen chloride removal step was calculated by measuring the proportion of a reduction in the concentration of the hydrogen chloride using the A method when the hydrogen chloride removal step is performed on the gas consisting of only hydrogen chloride and nitrogen gas, and multiplying the concentration of the hydrogen chloride in the gas after the chlorine gas decomposition step by the proportion of the reduction.

Next, the gas exhausted from the chlorine gas decomposition unit 10 was supplied to the hydrogen chloride removal unit 20 (water scrubber) to remove the hydrogen chloride in the hydrogen chloride removal unit 20. The supply rate of the gas exhausted from the chlorine gas decomposition unit 10 to the hydrogen chloride removal unit 20 was 5 L/min in terms of the standard state, and the supply rate of water was 0.5 mL/min. In addition, the temperature of water supplied to the hydrogen chloride removal unit 20 was 25° C.

After performing the removal of the hydrogen chloride for 1 hour, the gas exhausted from the hydrogen chloride removal unit 20 was collected to measure the concentrations of the chlorine gas, the octafluorocyclobutane, and the hydrogen chloride in the gas. Table 1 shows the results. A method of measuring the chlorine gas, the octafluorocyclobutane, and the hydrogen chloride is as described above.

Next, while supplying the gas exhausted from the hydrogen chloride removal unit 20 to the perfluoro compound decomposition unit 30, the decomposition of the perfluoro compound and the chlorine gas at 750° C. was performed in the perfluoro compound decomposition unit 30.

After performing the decomposition reaction of the perfluoro compound and the chlorine gas for 1 hour, the abatement gas exhausted from the perfluoro compound decomposition unit 30 was collected to measure the concentrations of the chlorine gas, the octafluorocyclobutane, and the hydrogen chloride in the gas. Table 1 shows the results. A method of measuring the chlorine gas, the octafluorocyclobutane, and the hydrogen chloride is as described above.

In addition, by substituting the measurement result of the concentration of the chlorine gas in the abatement gas into the following equation, the abatement ratio of the chlorine gas was calculated. Regarding the octafluorocyclobutane, the abatement ratio was calculated using the same method as that of the chlorine gas. Table 1 shows the results.

$$Abatement Ratio ( \% ) = \{ ( 0.5 - Concentration of Chlorine gas in Abatement Gas ( \% by volume ) ) / 0.5 \} \times 100$$

### Example 2

The treatment of the exhaust gas was performed using the same method as that of Example 1, except that the temperature at which the decomposition reaction of the chlorine gas was performed in the chlorine gas decomposition unit 10 was 750° C. Table 1 shows the results.

### Comparative Example 1

The treatment of the exhaust gas was performed using the same method as that of Example 1, except that the exhaust gas treatment device did not include the hydrogen chloride removal unit 20 and the gas exhausted from the chlorine gas decomposition unit 10 was supplied to the perfluoro compound decomposition unit 30. Table 1 shows the results. As can be seen from Table 1, in Comparative Example 1, the concentration of the chlorine gas in the abatement gas was not able to be sufficiently reduced as compared to Example 1.

### Comparative Example 2

The treatment of the exhaust gas was performed using the same method as that of Example 1, except that the exhaust gas treatment device did not include the chlorine gas decomposition unit 10 and the hydrogen chloride removal unit 20 and the perfluoro compound decomposition unit 30 was filled with both of the chlorine gas decomposition catalyst and the perfluoro compound decomposition catalyst. That is, while supplying the exhaust gas to the perfluoro compound decomposition unit 30, the decomposition of the perfluoro compound and the chlorine gas was performed at 750° C. in the perfluoro compound decomposition unit 30.

The perfluoro compound decomposition unit 30 is a reactor (volume: 105 mL) formed of Inconel (registered trademark), and the inside thereof is filled with 11 g of the same chlorine gas decomposition catalyst as that used in Example 1 and 80 g of the same perfluoro compound decomposition catalyst as that used in Example 1.

After performing the decomposition reaction of the perfluoro compound and the chlorine gas for 1 hour, the abatement gas exhausted from the perfluoro compound decomposition unit 30 was collected to measure the concentrations of the chlorine gas, the octafluorocyclobutane, and the hydrogen chloride in the gas. Table 1 shows the results. A method of measuring the chlorine gas, the octafluorocyclobutane, and the hydrogen chloride is as described above. The concentration of the hydrogen chloride in the abatement gas is not shown in Table 1 and is 9935 ppm by volume.

As can be seen from Table 1, in Comparative Example 2, the concentration of the chlorine gas in the abatement gas was not able to be sufficiently reduced as compared to Example 1.

### REFERENCE SIGNS LIST

10: chlorine gas decomposition unit
20: hydrogen chloride removal unit
30: perfluoro compound decomposition unit

1. An exhaust gas treatment method of treating exhaust gas containing chlorine gas and a perfluoro compound, the method comprising:
a chlorine gas decomposition step of causing the chlorine gas in the exhaust gas to react with water to be decomposed in a presence of a chlorine gas decomposition catalyst;
a hydrogen chloride removal step of removing hydrogen chloride from the gas having passed through the chlorine gas decomposition step; and
a perfluoro compound decomposition step of causing the perfluoro compound in the gas having passed through the hydrogen chloride removal step to react to be decomposed in a presence of a perfluoro compound decomposition catalyst.

2. The exhaust gas treatment method according to claim 1,
wherein the perfluoro compound decomposition step is a step of causing the perfluoro compound in the gas having passed through the hydrogen chloride removal step to react to be decomposed in the presence of the perfluoro compound decomposition catalyst and causing the chlorine gas in the gas having passed through the hydrogen chloride removal step to react to be decomposed in the presence of a chlorine gas decomposition catalyst.

3. The exhaust gas treatment method according to claim 1,
wherein the hydrogen chloride removal step is a step of removing the hydrogen chloride by bringing the gas having passed through the chlorine gas decomposition step into contact with water to dissolve the hydrogen chloride in the water.

4. The exhaust gas treatment method according to claim 1,
wherein a decomposition reaction of the chlorine gas in the chlorine gas decomposition step is performed at a temperature of 500° C. or higher and 800° C. or lower.

5. The exhaust gas treatment method according to claim 1,
wherein a decomposition reaction of the perfluoro compound in the perfluoro compound decomposition step is performed at a temperature of 500° C. or higher and 800° C. or lower.

6. An exhaust gas treatment device for treating exhaust gas containing chlorine gas and a perfluoro compound, the device comprising:
a chlorine gas decomposition unit including a chlorine gas decomposition catalyst and configured to cause the chlorine gas in the exhaust gas to react with water to be decomposed in a presence of the chlorine gas decomposition catalyst;
a hydrogen chloride removal unit configured to remove hydrogen chloride from the gas from which the chlorine gas is decomposed by the chlorine gas decomposition unit; and
a perfluoro compound decomposition unit including a perfluoro compound decomposition catalyst and configured to cause the perfluoro compound in the gas from which the hydrogen chloride is removed by the hydrogen chloride removal unit to react to be decomposed in a presence of the perfluoro compound decomposition catalyst.

7. The exhaust gas treatment device according to claim 6,
wherein the perfluoro compound decomposition unit includes a chlorine gas decomposition catalyst in addition to the perfluoro compound decomposition catalyst, causes the perfluoro compound in the gas from which the hydrogen chloride is removed by the hydrogen chloride removal unit to react to be decomposed in the presence of the perfluoro compound decomposition catalyst, and causes the chlorine gas in the gas from which the hydrogen chloride is removed by the hydrogen chloride removal unit to react to be decomposed in the presence of the chlorine gas decomposition catalyst.

8. The exhaust gas treatment device according to claim 6,
wherein the hydrogen chloride removal unit removes the hydrogen chloride by bringing the gas from which the chlorine gas is decomposed by the chlorine gas decomposition unit into contact with water to dissolve the hydrogen chloride in the water.

9. The exhaust gas treatment device according to claim 6,
wherein the chlorine gas decomposition unit performs a decomposition reaction of the chlorine gas at a temperature of 500° C. or higher and 800° C. or lower.

10. The exhaust gas treatment device according to claim 6,
wherein the perfluoro compound decomposition unit performs a decomposition reaction of the perfluoro compound at a temperature of 500° C. or higher and 800° C. or lower.

11. The exhaust gas treatment method according to claim 2,
wherein the hydrogen chloride removal step is a step of removing the hydrogen chloride by bringing the gas having passed through the chlorine gas decomposition step into contact with water to dissolve the hydrogen chloride in the water.

12. The exhaust gas treatment method according to claim 2,
wherein a decomposition reaction of the chlorine gas in the chlorine gas decomposition step is performed at a temperature of 500° C. or higher and 800° C. or lower.

13. The exhaust gas treatment method according to claim 2,
wherein a decomposition reaction of the perfluoro compound in the perfluoro compound decomposition step is performed at a temperature of 500° C. or higher and 800° C. or lower.

14. The exhaust gas treatment device according to claim 7,
wherein the hydrogen chloride removal unit removes the hydrogen chloride by bringing the gas from which the chlorine gas is decomposed by the chlorine gas decomposition unit into contact with water to dissolve the hydrogen chloride in the water.

15. The exhaust gas treatment device according to claim 7,
wherein the chlorine gas decomposition unit performs a decomposition reaction of the chlorine gas at a temperature of 500° C. or higher and 800° C. or lower.

16. The exhaust gas treatment device according to claim 7,
wherein the perfluoro compound decomposition unit performs a decomposition reaction of the perfluoro compound at a temperature of 500° C. or higher and 800° C. or lower.
